(19) United States
(12) Patent Application Publication
(10) Pub. No.: US 2018/0088796 A1
(43) Pub. Date: Mar. 29, 2018

(54) VIEW SWITCHING METHOD AND APPARATUS FOR TOUCH SCREEN, AND CLIENT DEVICE

(71) Applicant: GUANGZHOU UCWEB COMPUTER TECHNOLOGY CO., LTD., GUANGZHOU (CN)

(72) Inventors: ZHONGLIAN WU, GUANGZHOU (CN); JIANFENG WU, GUANGZHOU (CN)

(21) Appl. No.: 15/712,338

(22) Filed: Sep. 22, 2017

(30) Foreign Application Priority Data
Sep. 26, 2016 (CN) 201610851148.5

(51) Int. Cl. G06F 3/0488; G06F 3/0483

(52) U.S. Cl. CPC G06F 3/04883; G06F 3/0483

(57) ABSTRACT

A view switching method includes: displaying a switching flag on a current view in response to a first particular gesture of a user on the current view, where the first particular gesture passes through a particular area of the current view, and switching from the current view to a target view associated with the switching flag, in response to ending of the first particular gesture or to a second particular gesture of the user on the current view. Smooth switching to a specified view can reduce errors caused by mis-operations of users, and provide users with fast, convenient, and graceful browsing experience.

### CROSS-REFERENCE TO RELATED APPLICATION

This application is based on and claims priority to and benefits of Chinese Patent Application No. 201610851148.5, filed with the State Intellectual Property Office (SIPO) of the People's Republic of China on Sep. 26, 2016, the entire contents of which is incorporated herein by reference.

### TECHNICAL FIELD

The present application relates to interface interaction, and in particular, to a view switching method and apparatus for a touch screen, and a corresponding client device.

### RELATED ART

With the development of computer technologies and mobile Internet, devices with a touch screen, especially mobile devices with a touch screen, become more popular. Meanwhile, users more frequently use touch screen devices, especially smartphones, to browse web pages. Therefore, there is an urgent need for providing a simple, fast, and convenient interaction methods.

For browsers currently available on the market, a common method for returning to a home page is returning to a home page of a website first, and then returning to the home page of the browser by tapping a home page button provided and displayed in the home page of the website. This method requires complex operations and high operation costs of the user. In addition, although a tab specially used for returning to the home page (or other specified pages) may be set on the bottom, it occupies the limited tab space and affects the simplicity of the page displayed. For other applications on touch devices, a similar problem of inconvenient view returning or switching also exists.

Therefore, there is a need of a view switching for touch screens that is applicable to various applications including browsers, so as to facilitate smooth switching to a specified view.

### SUMMARY

One of the objectives of the present application is to implement smooth switching to a specified view by setting a fast gesture that satisfies users' thinking patterns and usage habits, thereby reducing errors caused by mis-operations of users, and provide users with fast, convenient, and graceful browsing experience.

According to an aspect of the present disclosure, a view switching method for a touch screen is provided, including: displaying a switching flag on a current view in response to a first particular gesture of a user on the current view, where the first particular gesture passes through a particular area of the current view; and switching from the current view to a target view associated with the switching flag, in response to ending of the first particular gesture or to a second particular gesture of the user on the current view.

In this way, the user can conveniently return to an expected target view by means of a particular gesture, making operations on the touch screen smoother, thereby improving user experience.

The first particular gesture may be one of the following: a gesture starting from the particular area, a gesture ending at the particular area, a gesture passing by the particular area, or tapping, double tapping, or pressing on the particular area. Because the particular gesture passes through the particular area, the particular gesture can be more conveniently distinguished from an ordinary page operation gesture, so that the present solution can be implemented more easily.

In one embodiment, the first particular gesture includes a swiping action. More preferably, the first particular gesture includes one of the following: a swiping action starting from the particular area, a swiping action ending at the particular area, or a swiping action passing by the particular area. Because the particular gesture is a swiping operation passing through the particular area that is similar to an ordinary swiping operation, convenience and smoothness of the view switching operation can be ensured, thereby improving user experience.

In one embodiment, the switching flag includes at least an unstable display state and a stable state, and the switching flag is stably displayed in the stable state after the swiping action exceeds a predetermined distance or the touch screen is pressed for longer than a predetermined time. The appearance of the unstable state can be used to remind the user that the action of the user is triggering a view switching operation, and subsequently the user can perform an action to confirm or stop the switching operation.

In one embodiment, the second particular gesture may be an action of tapping or double tapping the switching flag. An action for finally performing view switching can be determined according to requirements.

In one embodiment, the particular area is located at a lower part of the current view. The particular area may be a text display bar adjacent to and above a tab located at the bottom of the current view. Therefore, the view switching operation of the present application is facilitated, especially for handheld devices.

In one embodiment, the first particular gesture may be an upward-swiping action starting from the text display bar. Therefore, the switching action can be conveniently and gracefully implemented.

In one embodiment, the view may be a page displayed on a touch screen, and the target view is a home page of a site or an application. The view switching solution of the present application is particularly applicable to a page browse application that needs to be entered by tapping layer by layer, so as to implement direct switch of pages separated by multiple layers.

According to another aspect of the present invention, a view switching apparatus for a touch screen is provided, including: a switching flag display unit, configured to display a switching flag on a current view in response to a first particular gesture of a user on the current view, where the first particular gesture passes through a particular area of the current view; and a target view switching unit, configured to switch from the current view to a target view associated with the switching flag, in response to ending of the first particular gesture or to a second particular gesture of the user on the current view.

The first particular gesture may include one of the following: a swiping action starting from the particular area, a swiping action ending at the particular area, or a swiping action passing by the particular area.

The switching flag may include at least an unstable display state and a stable state, and the switching flag is stably displayed in the stable state after the swiping action exceeds a predetermined distance or the touch screen is pressed for longer than a predetermined time.

In one embodiment, the particular area is a text display bar adjacent to and above a tab located at the bottom of the current view, and the first particular gesture is an upward-swiping action starting from the text display bar.

According to another aspect, the present disclosure provides a non-transitory computer-readable storage medium storing instructions that, when executed by a processor of a computer system, cause the computer system to perform a method comprising displaying a switching flag on a current view in response to a first particular gesture of a user on the current view, wherein the first particular gesture passes through a particular area of the current view, and switching from the current view to a target view associated with the switching flag, in response to ending of the first particular gesture or to a second particular gesture of the user on the current view.

According to still another aspect of the present invention, a client device is provided, including: a touch screen, configured to receive input information and display output information; a memory storing instructions; and a processor, connected to the touch screen and the memory, where, when the processor executes the instructions, the processor is configured to: display a switching flag on a current view of the touch screen in response to a first particular gesture of a user on the current view, where the first particular gesture passes through a particular area of the current view; and switch from the current view to a target view associated with the switching flag, in response to ending of the first particular gesture or to a second particular gesture of the user on the current view.

According to the view switching method and apparatus and the client device of the present invention, smooth view switching can be implemented by simple operations on the touch screen, thereby improving user experience.

### BRIEF DESCRIPTION OF THE DRAWINGS

The foregoing and other objectives, features, and advantages of the present disclosure will become more obvious from the detailed description of exemplary embodiments of the present disclosure with reference to the accompany drawings. In the exemplary embodiments of the present disclosure, like reference numerals generally represent like parts.

FIG. 1 illustrates a view switching method for a touch screen according to an embodiment of the present invention;

FIG. 2 illustrates a view switching apparatus for a touch screen according to an embodiment of the present invention;

FIG. 3 illustrates a client device according to an embodiment of the present invention; and

FIG. 4a to FIG. 4d illustrate page screenshots using the technical solution of the present invention.

### DETAILED DESCRIPTION

The following will describe in detail preferred embodiments of the present disclosure with reference to accompany drawings. Although preferred embodiments of the present disclosure are illustrated in the accompany drawings, it should be understood that the present disclosure may be implemented in various forms, but is not limited to the embodiments described herein. These embodiments are provided to enable a more thorough and understanding of the present disclosure.

In the prior art, the degree of convenience of view switching is usually related to the number of levels spaced between two views. For example, when a user uses a browser to browse a page of a particular website, if the user wants to return to a home page of the browser, the user needs to return to a home page of the website first, and then return to the home page of the browser. The difference between levels of pages leads to inconvenient operations. Furthermore, for other applications (such as applications installed on a mobile phone), usually switching between non-adjacent views also requires multiple operations, leading to great inconvenience. In view of the foregoing problem, the present application, by means of a particular area of an application (for example, the bottom area of a view that can be easily reached when a handheld device is used), a user can switch to a specified view (for example, returning to a home page) quickly by performing simple operations, thereby providing the user with novel, interesting, and smooth operation experience.

As seen above and described in detail below, the present application provides technical solutions that change how a user interact with a computer system, such as a touch screen device. According to some embodiments, by programing the computer system with specific instructions, the computer functionalities, in particular, in the area of interface, are improved to make the computer system more convenient to use. The computer system can more quickly receive and respond to a user's need. Thus, the present invention improves efficiency of the user and the computer system.

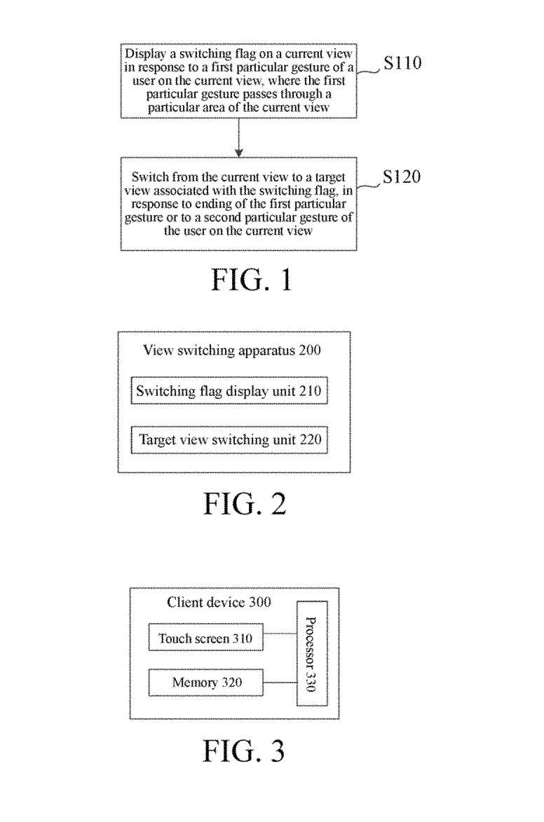

FIG. 1 illustrates a view switching method for a touch screen according to an embodiment of the present invention.

Step S110: Display a switching flag on a current view in response to a first particular gesture of a user on the current view, where the first particular gesture passes through a particular area of the current view. Herein, passing through the particular area may be starting from the particular area, passing by the particular area, or ending at the particular area, or even may be tapping, double tapping or continuous pressing on the particular area. Therefore, the first particular gesture may be a gesture starting from the particular area, a gesture ending at the particular area, or a gesture passing by the particular area. In addition, the first particular gesture may include a swiping action. The first particular gesture passes through the particular area, thus, the first particular gesture can be distinguished from an ordinary swiping gesture during view browsing. Therefore, the first particular gesture may be a swiping action starting from the particular area, a swiping action ending at the particular area, or a swiping action passing by the particular area, and may also be an action that includes one or more the foregoing actions. In one embodiment, the first particular gesture may include swiping starting from the particular area towards a particular direction. In another embodiment, the first particular gesture may be a swiping action that has a particular track and passes by or ends at the particular area. For example, the first particular gesture may be a gesture that swipes by a particular distance towards one direction and then swipes towards another direction after reaching the particular area (that is, a gesture whose swiping track is a curved line). It will be appreciated that these are merely examples of specific implementations of the first particular gesture, not exhaustive. A person skilled in the art could also conceive of other implementations of the first particular gesture passing through the particular area of the current view.

Step S120: Switch from the current view to a target view associated with the switching flag, in response to ending of the first particular gesture or to a second particular gesture of the user on the current view. The switching flag is a flag used to indicate that a switch to the target view is to be performed. In one embodiment, the switching flag may be merely a flag. After the switching flag appears, ending of the first particular gesture (for example, a hand of a user leaves the touch screen) may directly trigger the switching from the current view to the target view. In other embodiments, a switching flag may be a virtual button. After the first particular gesture ends, the user may perform an operation on the switching flag by using a second particular gesture (for example, tapping or double tapping the switching flag) to implement view switching. In addition, when an operation needs to be performed on the switching flag to perform view switching, if the user does not perform any operation on the switching flag within a specified time after the switching flag is displayed, the switching flag may be hidden.

In one embodiment, the switching flag may include at least an unstable display state and a final stable display state. Therefore, a user can learn that a current action can trigger view switching. In this way, the user may continue to perform an action meeting the first particular gesture so as to implement the switching, or the user may stop the action to avoid switching. In one embodiment, the first particular gesture may include a start phase and a confirmation phase. In the start phase, a switching flag that is not stably displayed may appear on the screen, such as a flickering switching flag, a continuously rising or a hidden switching flag, or a switching flag of a particular color. If the user intends to perform view switching, the user may continue to perform the first particular gesture to the confirmation phase. In the confirmation phase, the switching flag is stably displayed, for example, stably displayed at a same position in a stable color. The start phase and the confirmation phase are preferably different parts of a coherent action. In one embodiment, the switching flag is stably displayed in the stable state after the swiping action exceeds a predetermined distance. The switching flag may alternatively be displayed in the stable state after the touch screen is pressed for longer than a predetermined time. In one embodiment, the switching flag may alternatively be displayed in the stable state after the user instantly changes the swiping direction (for example, from upward-swiping to downward-swiping). After the switching flag is stably displayed, it may be specified that view switching is to be triggered by ending the first particular gesture (for example, leaving the hand from the touch screen) by the user, or be triggered by tapping or double tapping the switching flag by the user. In one embodiment, the transition between the stable state and the unstable state may be bidirectional. For example, after the switching flag is displayed in the stable state, the switching flag may return to the unstable state in the case of movement in a reverse direction.

Herein, the switching flag may have any shape and pattern. In some embodiments, the switching flag may have a color or contour that can be distinguished from the background of the view, and include an icon that can indicate a target view to be switched to. For example, when the embodiment of the present application is applied to switching of any current page to a home page of a browser, a button that has a home page icon may be displayed as the switching flag.

In one embodiment, the particular area can be located at a lower part of the view. This is particularly applicable to an application of a handheld device of a user, such as a smartphone. Because the user of the smartphone usually gets used to holding the phone with a single hand to perform various operations such as swiping and tapping, the particular area located at the lower part of the view can facilitate operations of the user, especially for the current development trend of mobile phones towards a larger screen. In one embodiment, a text display bar used for displaying website or page information may be set to be adjacent to and above a tab located at the bottom of the view. The particular area of may be the text display bar. The first particular gesture may be an upward-swiping action starting from the text display bar. Correspondingly, the switching flag may also be displayed at the lower part of the view to indicate a relationship with the particular area. For example, the switching flag may be displayed as rising from the text display bar and is displayed above the text display bar.

The view switching method of the embodiments of the present application are described above with reference to FIG. 1. It will be appreciated that in actual applications, the features of the embodiments may be combined to obtain a new implementation solution. For example, when the first particular gesture is a swiping action starting from the bottom area of the view, the switching flag in an unstable state may appear after the swiping action reaches a particular distance. Then, after the swiping action continues and exceeds a threshold distance, or after the screen is pressed for longer than a predetermined time, or the user swipes on the screen along another particular track, the switching flag will be stably displayed. In addition, the technical solution of the present invention may be applied to any application, especially a mobile-side application. In one embodiment, the mobile-side application may be a browser application. Therefore, a view of the application is a page displayed on the touch screen, and a target view may preferably be a particular site or a home page of the browser application. In one embodiment, the mobile-side application may be an instant communication application integrated with multiple functions. By means of the technical solution of the present invention, a user can quickly return to a particular view such as a personal home page view of the user or a payment view by performing a particular gesture operation. In addition, different gestures (which may pass through a same particular area or different particular areas) may further be set for a same application to redirect to different pages. The technical solution of the present invention is particularly applicable to an application including multiple functions.

The following describes module and hardware implementations of the technical solution of the present invention with reference to FIG. 2 and FIG. 3. FIG. 2 is a view switching apparatus 200 for a touch screen according to an embodiment of the present invention. The apparatus 200 includes a switching flag display unit 210 and a target view switching unit 220. The switching flag display unit 210 displays a switching flag on a current view in response to a first particular gesture of a user on the current view. The first particular gesture passes through a particular area of the current view. The target view switching unit 220 switches from the current view to a target view associated with the switching flag, in response to ending of the first particular gesture or to a second particular gesture of the user on the current view. Similar to the foregoing description of the method, the first particular gesture may also include the following: a swiping action starting from the particular area; a swiping action ending at the particular area; or a swiping action passing by the particular area.

In one embodiment, the switching flag includes at least an unstable display state and a stable state. The switching flag display unit 210 may display the switching flag in the unstable state in a start phase of the first particular gesture, and stably display the switching flag when the user continues to perform the first particular gesture to a confirmation phase. In one embodiment, the switching flag display unit 210 may stably display the switching flag in the stable state after the swiping action exceeds a predetermined distance.

It will be appreciated that the foregoing preferred embodiments described about the particular gesture and the particular area based on the method embodiments also apply to this module embodiment described with reference to FIG. 2. For example, the particular area may also be a text display bar adjacent to and above a tab located at the bottom of the view, and the first particular gesture may also be an upward-swiping action starting from the text display bar.

FIG. 3 illustrates a client device 300 according to an embodiment of the present invention. The client device 300 includes a touch screen 310, a memory 320, and a processor 330. The touch screen 310 is configured to receive input information and display output information. The memory 320 is configured to store information. The processor 330 is connected to the touch screen 310 and the memory 320, and is configured to: display a switching flag on a current view of the touch screen 310 in response to a first particular gesture of a user on the current view, where the first particular gesture passes through a particular area of the current view; and switch from the current view to a target view associated with the switching flag, in response to ending of the first particular gesture or to a second particular gesture of the user on the current view.

It will be appreciated that the foregoing preferred embodiments about the particular gesture, the particular area, and the switching flag also apply to the client device here. Therefore, details are not described herein again. Similarly, it will be appreciated that the client device 300 of the present invention may further include other apparatus for implementing its functions, for example, a communications apparatus for interacting with the outside. Such apparatus will not be described in detail herein, so as to avoid obscuring the principle of the present invention.

The view switching method and apparatus for a touch screen and the client device of the present invention are described in detail above with reference to FIG. 1 to FIG. 3. The following further describes the principle of the present invention by using specific examples.

### Examples

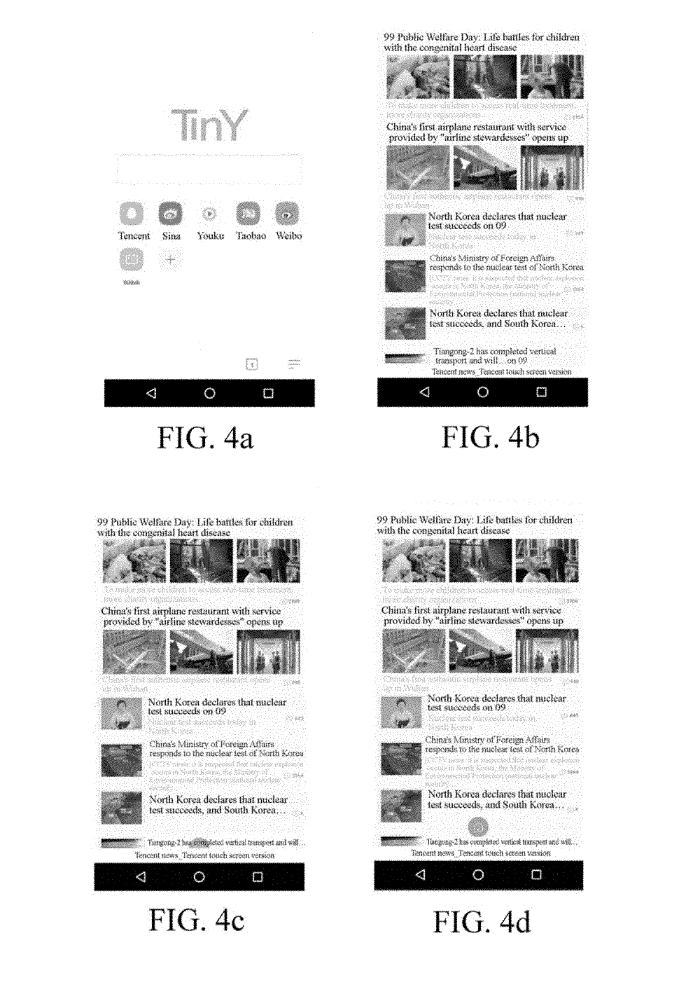

To more intuitively explain the advantages of the present invention, a specific example of the technical solution of the present invention is described below with reference to FIG. 4. FIG. 4a to FIG. 4d illustrate page screenshots using the technical solution of the present invention. As shown in the drawings, the technical solution of the present invention is applied to an application with a browsing function on a smartphone. Therefore, in this exemplary embodiment, view switching is page switching.

Specifically, a user may browse a web page by using a browser application or an application with a corresponding module. For example, the user is currently browsing a web page. When the user wants to return to a home page (or any specified page) of the browser, the user may first touch a particular area on the screen, such as a text display bar, and then touches and holds the screen and swipes upwards. In this case, a flag for returning to the home page (or any specified page) slowly appears on the page. As the swiping distance increases, the flag changes to different degrees. Finally, a stable home page (or any specified page) flag appears after the swiping action reaches a particular distance. After the user moves the hand away from the screen, the home page (or any specified page) is returned to. FIG. 4a illustrates a home page of an application. FIG. 4b is a “Tencent news” page entered by default after a user taps the icon “Tencent” in FIG. 4a. FIG. 4b further illustrates a text display bar located above the bottom tab, that is, a bar-shaped part that displays “Tencent news_Tencent touch screen version” in the figure. Then, the user performs the first particular gesture. In this example, the first particular gesture may be touching and holding the text display bar, and swiping upwards. When the upward-swiping distance exceeds a particular threshold, as shown in FIG. 4c, a circular switching icon rises from the text display bar. When the user continues to swipe upwards, the switching icon is stably displayed above the text display bar, for example, in a different color. In this case, if the user moves the hand away from the touch screen, the page is automatically redirected to the browser home page identified by the switching icon, such as the page shown in FIG. 4a. In this example, switching to the home page can be conveniently and rapidly implemented by simply performing the upward-swiping action starting from the text display bar at the bottom of the view and the action of moving the hand away from the screen. This example is particularly applicable to the most common usage scenario in which the user operates a smartphone with a single hand.

It will be appreciated that the example provided herein is merely a specific embodiment of the technical solution of the present invention, and is not intended to limit the present invention in any aspect. In actual applications, fast switching between any views can be implemented for any application (preferably, a smartphone application). Displaying of the switching flag may be implemented by any action that passes by the particular area along any track. When the switching flag has multiple states, unidirectional or bidirectional transition between the multiple states may be implemented according to specific applications. All such specific applications shall fall within the scope covered by the claims of the present invention.

User experience and interaction of an application can determine a preferred degree of the user for the application, and importance of the user experience and interaction is obvious. In addition, a good and smooth interaction experience can greatly improve freshness and happiness of the user, so as to improve a complete experience of the user for functions. In the technical solution of the present invention, a gesture passing through a particular area is used to implement a particular switching, so that the user can rapidly return to a target view, thereby greatly reducing errors caused by mis-operations of the user, and providing users with fast, convenient, and graceful browsing experience. Meanwhile, the solution has high expansibility, and enables any application to rapidly return to a particular view, for example, return to its home page.

In addition, the method according to the present invention may also be implemented as a computer program. The computer program includes computer program code instructions used to perform the steps defined in the method of the present invention. Alternatively, the method according to the present invention may be implemented as a computer program product. The computer program product includes a non-transitory computer readable storage medium, and the computer readable medium stores a computer program used to perform functions defined in the method of the present invention. A person skilled in the art should understand that various exemplary logical blocks, modules, circuits, and algorithm steps described with reference to the disclosure herein may be implemented as electronic hardware, computer software, or a combination thereof.

Flowcharts and/or block diagrams in accompany drawings display system architectures, functions, and operations that may be implemented according to the system and the method of embodiments of the present invention. On this point, each block in the flowcharts or the block diagrams may represent a part of a module, a program segment, or code. The part of the module, the program segment, or the code includes one or more executable instructions used for implementing prescribed logical functions. It should be noted that in some replaceable implementations, functions marked in the blocks may also occur in a sequence different from that marked in the accompany drawings. For example, actually, two continuous blocks may be basically executed in parallel, or sometimes be executed according to a reverse sequence, and this is determined by involved functions. It should also be noted that each block in the block diagrams and/or the flowcharts, and a combination of blocks in the block diagrams and/or the flowcharts may be implemented by a hardware-based system dedicated for performing prescribed functions or operations, or by a combination of dedicated hardware and a computer instruction.

Embodiments of the present invention are described above. The foregoing description is exemplary, not for an exhaustive purpose, and is not limited to the disclosed embodiments. Without departing from the spirit and scope of the described embodiments, many amendments and changes are obvious to a person of ordinary skill in the art. Selections of terms used in this text aim at best explaining principles of the embodiments, actual applications, or improvements to technologies in the market, or enabling other persons of ordinary skill in the art to understand the embodiments disclosed in this text.

What is claimed is:

1. A view switching method for a touch screen, comprising:
displaying a switching flag on a current view in response to a first particular gesture of a user on the current view, wherein the first particular gesture passes through a particular area of the current view; and
switching from the current view to a target view associated with the switching flag, in response to ending of the first particular gesture or to a second particular gesture of the user on the current view.

2. The method according to claim 1, wherein the first particular gesture is one of the following:
a gesture starting from the particular area;
a gesture ending at the particular area;
a gesture passing by the particular area; or
tapping, double tapping, or pressing on the particular area.

3. The method according to claim 2, wherein the first particular gesture comprises a swiping action.

4. The method according to claim 2, wherein the first particular gesture comprises one of the following:
a swiping action starting from the particular area;
a swiping action ending at the particular area; or
a swiping action passing by the particular area.

5. The method according to claim 3, wherein the switching flag comprises at least an unstable display state and a stable display state, and the switching flag is stably displayed in the stable display state after the swiping action exceeds a predetermined distance or the touch screen is pressed for longer than a predetermined time.

6. The method according to claim 1, wherein the second particular gesture is an action of tapping or double tapping the switching flag.

7. The method according to claim 1, wherein the particular area is located at a lower part of the current view.

8. The method according to claim 7, the particular area is a text display bar adjacent to and above a tab located at the bottom of the current view.

9. The method according to claim 8, wherein the first particular gesture is an upward-swiping action starting from the text display bar.

10. The method according to claim 1, wherein the current view is a page displayed on the touch screen, and the target view is a home page of a site or an application.

11. A non-transitory computer-readable storage medium storing instructions that, when executed by a processor of a computer system, cause the computer system to perform a method comprising:
displaying a switching flag on a current view in response to a first particular gesture of a user on the current view, wherein the first particular gesture passes through a particular area of the current view; and
switching from the current view to a target view associated with the switching flag, in response to ending of the first particular gesture or to a second particular gesture of the user on the current view.

12. The non-transitory computer-readable storage medium according to claim 11, wherein the first particular gesture comprises one of the following:
a swiping action starting from the particular area;
a swiping action ending at the particular area; or
a swiping action passing by the particular area.

13. The non-transitory computer-readable storage medium according to claim 12, wherein the switching flag comprises at least an unstable display state and a stable display state, and the switching flag display unit stably displays the switching flag in the stable display state after the swiping action exceeds a predetermined distance or the touch screen is pressed for longer than a predetermined time.

14. The non-transitory computer-readable storage medium according to claim 11, wherein the particular area is a text display bar adjacent to and above a tab located at the bottom of the current view, and the first particular gesture is an upward-swiping action starting from the text display bar.

15. A client device, comprising:
a touch screen, configured to receive input information and display output information;
a memory that stores instructions; and
a processor, connected to the touch screen and the memory, wherein, when the processor executes the instructions, the processor is configured to:
display a switching flag on a current view of the touch screen in response to a first particular gesture of a user on the current view, wherein the first particular gesture passes through a particular area of the current view; and
switch from the current view to a target view associated with the switching flag, in response to ending of the first particular gesture or to a second particular gesture of the user on the current view.

16. The client device according to claim 15, wherein the first particular gesture is one of the following:
a gesture starting from the particular area;
a gesture ending at the particular area;
a gesture passing by the particular area; or
tapping, double tapping, or pressing on the particular area.

17. The client device according to claim 15, wherein the first particular gesture comprises a swiping action.

18. The client device according to claim 15, wherein the first particular gesture comprises one of the following:
a swiping action starting from the particular area;
a swiping action ending at the particular area; or
a swiping action passing by the particular area.

19. The client device according to claim 15, wherein the switching flag comprises at least an unstable display state and a stable display state, and the switching flag is stably displayed in the stable display state after the swiping action exceeds a predetermined distance or the touch screen is pressed for longer than a predetermined time.

20. The client device according to claim 15, the particular area is a text display bar adjacent to and above a tab located at the bottom of the current view.
